(19) United States
(12) Patent Application Publication
(10) Pub. No.: US 2025/0232331 A1
(43) Pub. Date: Jul. 17, 2025

(54) SYSTEM AND METHOD FOR ENHANCING MODEL TRAINING WITH OUTLIER CONVERSION DETECTION

(71) Applicant: Yahoo Ad Tech LLC, New York, NY (US)

(72) Inventors: Rina Leibovits, Haifa (IL); Yohay Kaplan, Haifa (IL); Oren S Somekh, Kfar-Netter (IL)

(21) Appl. No.: 18/410,106

(22) Filed: Jan. 11, 2024

(51) Int. Cl. G06Q 30/0242

(52) U.S. Cl. CPC G06Q 30/0246

(57) ABSTRACT

In an example, sets of event information associated with events may be identified. The events may include conversion events having affinity between conversion actions and associated ad clicks and outlier conversion events. Outlier bias associated with the outlier conversion events may be determined for content items. Machine learning model training may be performed, using only the sets of event information associated with the conversion events having affinity between conversion actions and associated ad clicks, to generate a machine learning model. Conversion probabilities associated with content items may be determined using the machine learning model and the calculated biases. A content item may be selected for presentation via a client device based upon the conversion probabilities.

### BACKGROUND

Many publishers of digital content provide various digital platforms for viewing their content—platforms such as websites, social media applications, mail applications, mobile apps, etc. Such publisher platforms may provide opportunities for publishers to request third parties, such as advertisers, to bid on the use of portions of their platform display (e.g., portions of publisher webpages, user interfaces, screens, etc.) to display third party digital content along with the publisher's content, such as advertisements, media, video, etc. Such publisher platforms also present opportunities for third parties, such as advertisers, to potentially display their content to a wide audience, and such third parties may wish to bid on one or more rights to utilize the publisher's display portions for displaying the third-party content.

Content serving platforms may provide real time bidding auctions where publishers may request that third parties bid on opportunities to utilize portions of the publisher's display, and third parties may bid on such requests, and where the content of the winning bid may be served to the publisher's display portion. As such, the bid values used in the auction process are of great importance. Often, such bid values may be based in part on the predicted probability that the content items involved in the bid may be converted by an end user to a tangible result for the third party—a result such as making a purchase, signing up for a service, downloading an article, etc.

Often, however, the auction process may use bid values that are based on conversion probabilities that are calculated based on data that contains unforeseen bias and that may result in bid values that are less accurate in reflecting user intentions as they may relate to conversion events.

### SUMMARY

In accordance with the present disclosure, one or more systems and/or methods are provided. In an example, in connection with a content serving system, a first plurality of sets of event information associated with a first plurality of conversion events is identified. The first plurality of sets of event information is filtered to identify a second plurality of sets of event information and a third plurality of sets of event information. The second plurality of sets of event information is associated with a plurality of typical conversion events identified from among the first plurality of conversion events. The third plurality of sets of event information is associated with a plurality of outlier conversion events identified from among the first plurality of conversion events.

Machine learning model training is performed, using the second plurality of sets of event information, to generate a machine learning model. A plurality of bias values associated with a plurality of content items are calculated based on the third plurality of sets of event information. A request for content associated with a client device is received by a content serving system. Responsive to receiving the request, a plurality of associated conversion probabilities are determined, for the plurality of content items, using the machine learning model and plurality of bias values. A content item from the plurality of content items is selected for presentation via the client device, based upon the plurality of associated conversion probabilities.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a chart illustrating a probability mass function of conversion event delay times for an example advertisement.

FIG. 5 is a flow chart illustrating an example method for determining conversion probabilities associated with content items and/or selecting content for transmission to devices, in accordance with one or more embodiments set forth herein.

FIG. 6 is a component block diagram illustrating an example system for determining conversion probabilities associated with content items and/or selecting content for transmission to devices, in accordance with one or more embodiments set forth herein.

FIG. 7 is an illustration of a scenario featuring an example non-transitory machine-readable medium in accordance with one or more embodiments set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein.

Rather, example embodiments are provided merely to be illustrative. Such embodiments may, for example, take the form of hardware, software, firmware or any combination thereof.

### 1. Computing Scenario

The following provides a discussion of some types of computing scenarios in which the disclosed subject matter may be utilized and/or implemented.

### 1.1. Networking

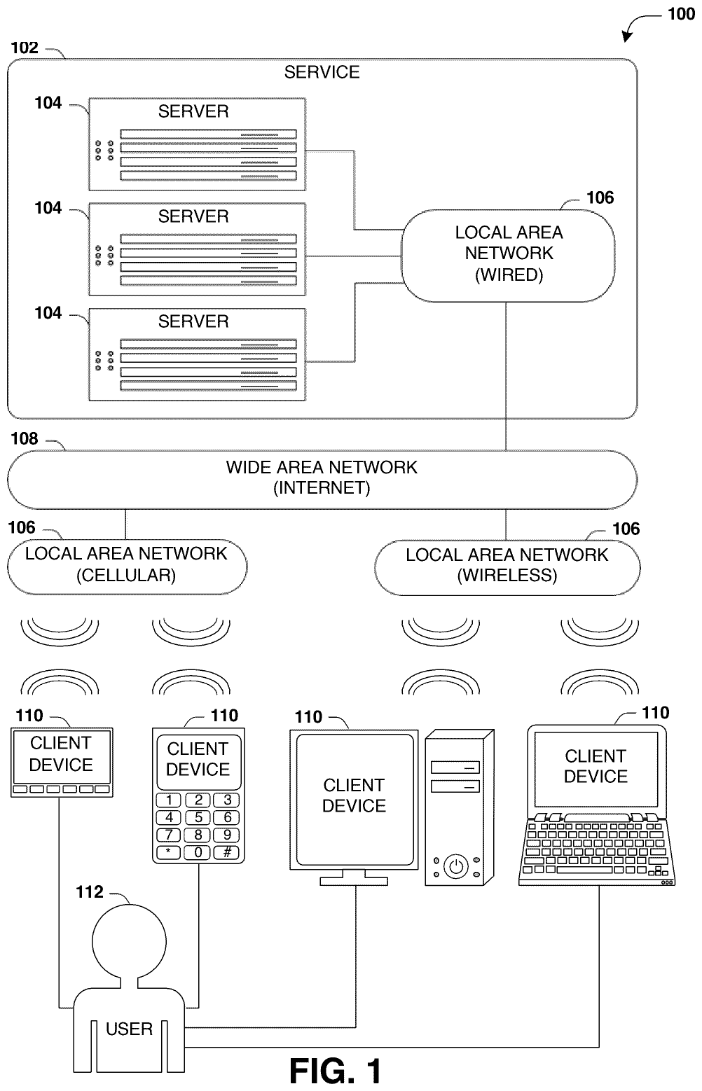

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP)). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ different architectures, may be compliant or compatible with differing protocols and/or may interoperate within the local area network 106. Additionally, a variety of local area networks 106 may be interconnected; e.g., a router may provide a link between otherwise separate and independent local area networks 106.

In scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

### 1.2. Server Configuration

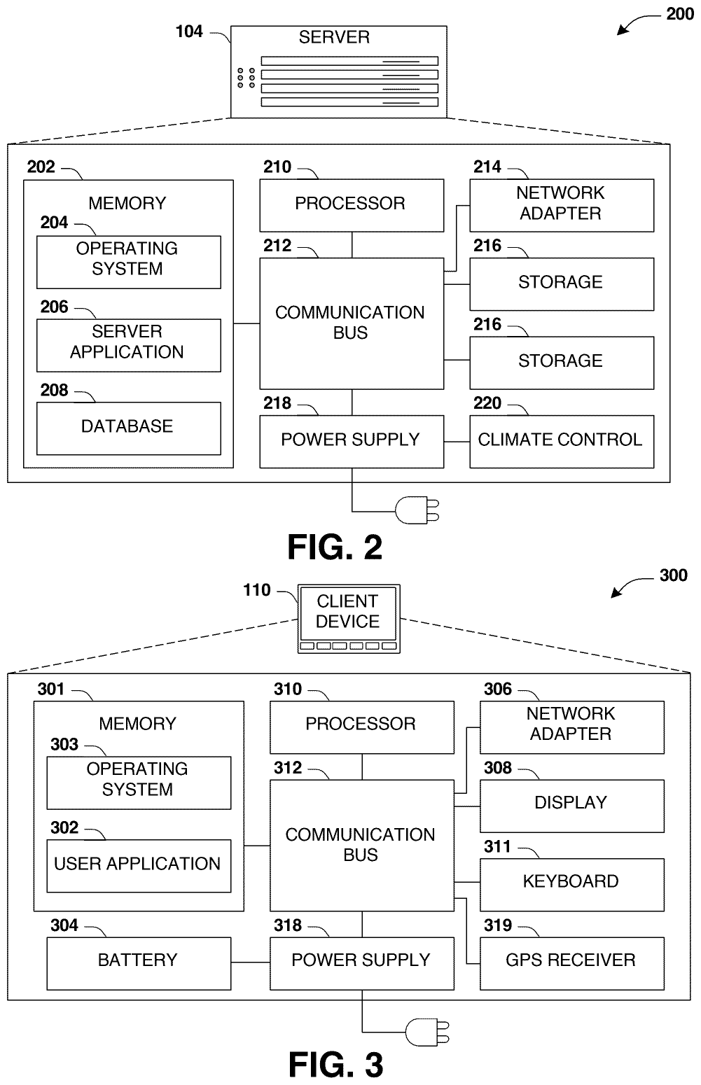

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic architecture diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

### 1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

### 2. Presented Techniques

One or more systems and methods for determining post-click conversion probabilities associated with content items and/or selecting content for transmission to devices are provided. For example, a first user (and/or a first client device associated with the first user) may access and/or interact with a service, such as a browser, software, a website, an application, an operating system, etc. that provides a platform for viewing and/or downloading content from a server associated with a content serving system/platform. In some examples, in response to receiving a request for content associated with the first client device, the content serving system may determine conversion probabilities associated with a plurality of content items (e.g., advertisements, images, links, videos, etc.) that are hosted, stored or accessed by the system. The conversion probabilities may be used to select a content item, from the plurality of content items, for presentation via the first client device.

In general, as mentioned, selecting content items by some content serving systems, such as those involved in the systems and methods disclosed herein, may involve determining predictions of conversion rates (CVRs) (conversion probabilities) for individual content items served by the content serving system. A conversion event may be understood to be a user taking a predefined action (often predefined by an advertiser) after either clicking on the content (post-click conversions) or viewing the content (post-view conversions). As used herein, unless context dictates otherwise, the term “conversion” and “conversion event” may be understood to refer to only post-click conversions. In general, the predefined action may be any relevant action as defined in the context of the system, such as, e.g., certain actions in an advertiser's system (e.g., website) associated with the content that was clicked on—e.g., purchasing a product, adding a product to a cart, signing a form, installing an app, etc. In addition, to qualify as a conversion event, the predefined event generally must occur within a predefined (by, e.g., the content provider, advertiser) window of time after the user has clicked on the content in question. Unlike clicks, which usually come within seconds after a user sees a content item (e.g., ad), a conversion event may come within hours or even days after a click.

Conversion event data may be used to train one or more models that may be used by the content serving system to predict the conversion rates (determine conversion probabilities) associated with the content items. When a predefined time window used to define conversion events is set that is significantly longer than the typical conversion delay of the content items in question, the conversion event data may incorporate outliers. These outliers denote conversion events with a delay that deviates significantly from the expected range. The significant and atypical delay between the click and the conversion predefined action raises doubts about the affinity between the two. For instance, to illustrate, consider a user who makes weekly purchases of a product from an advertiser. That user may click on an advertisement for the product earlier in the week from one of his weekly purchases. The purchase may erroneously be attributed as a conversion of that ad resulting from that click, when in reality there is little or no affinity between the two. This user profile could substantially differ from the profiles of users who made purchases because of clicking the advertisement. If the model was trained on conversion event data that did not differentiate between such occurrences and/or take into account such lack of affinity, this user data has the potential to mislead the model and impact its accuracy.

Currently, models do not differentiate between the two types of conversion events (i.e., those due to an affinity between the click and conversion predefined action and those that may not have such affinity—outliers). As a result, this data and models based on it have potential to be less than accurate. However, discarding the outlier data altogether when making a determination for serving content could lead to determinations that underpredicts the actual conversion rate. In general, the systems and methods herein train conversion probability models without reliance on outlier conversion event data, but do take such data into account when using the models to determine which content items to serve. Accordingly, the content serving systems of the embodiments disclosed herein are configured in a manner that provides content item serving determinations that more accurately reflect user (advertiser, platform provider, end user) intentions and behaviors.

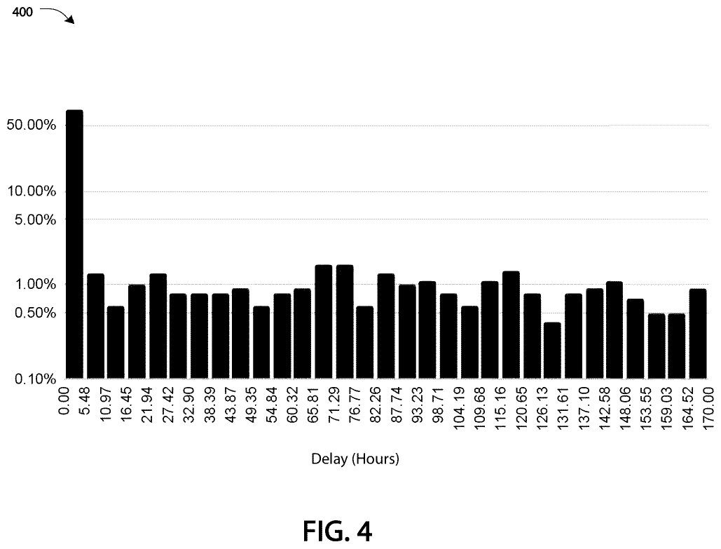

To illustrate, FIG. 4 shows a probability mass function (histogram, log scale) 400 for exemplary conversion event delay data for an exemplary advertiser's content items. As may be seen from FIG. 4, the advertiser's predefined time window for its conversion data is 168 hours (one week). Also, as may be seen, the majority of the conversion event samples (72.5%) happen within the first 5 hours. Beyond the first peak, the remaining portion of the probability mass function, uniformly and consistently maintains a probability density of ˜1% across the entire week, suggesting the presence of a constant conversion probability in relation to the advertisement content item, unrelated to click event context.

It should be noted, unless context dictates otherwise, the terms “conversion” and “predefined action” may be used interchangeably herein. Also, it should be noted, unless context dictates otherwise, a “conversion event” may comprise a click on a content item and a conversion/predefined action attributed to the click, together with contextual information (e.g., user information, device information, content item information, etc.) as more fully described below. Note that, unless context dictates otherwise, models and conversion event data sets may be understood to apply to advertisers (e.g., across content items), but that such systems and methods may also be applied at different levels, such as per campaign, per ad group, etc.

The systems and methods disclosed herein exclude conversion outliers when training system models, but incorporate them as a general bias when using the model to predict conversion rates when serving content items. This is counterintuitive and surprising, because excluding conversion event data from a data set leads to more accurate probability calculations (rather than less accurate, as would be expected) according to the systems and methods disclosed herein.

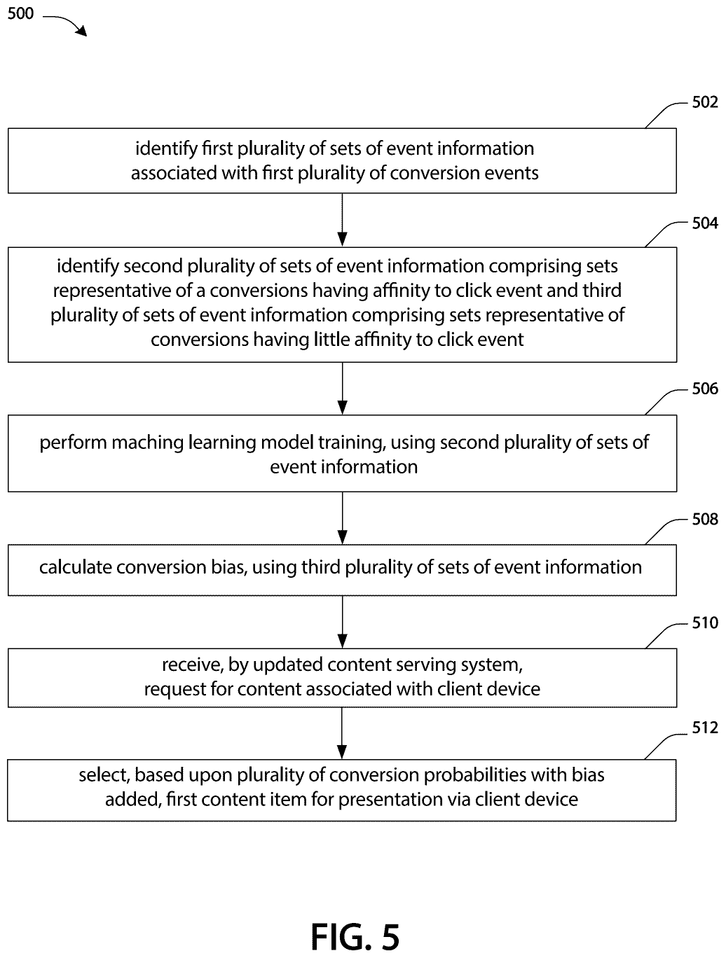

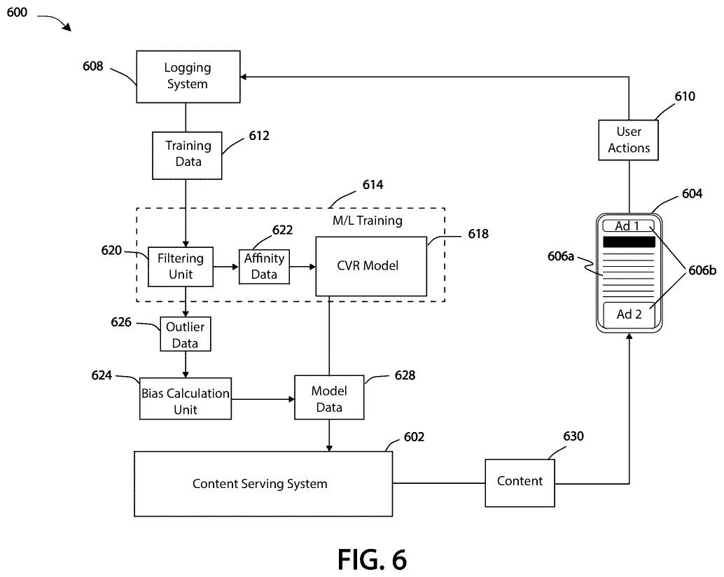

An embodiment of determining conversion probabilities associated with content items and/or selecting content for transmission to devices is illustrated by an example method 500 of FIG. 5, and is further described in conjunction with system 600 of FIG. 6.

In general, a content serving system, such as content serving system 602, may serve users with content items which may be displayed through a publisher's display/medium displayed on computing devices, such as client mobile device 604. It may be noted that, for the sake of clarity and ease of reference, the description to follow may only reference one type of content item (advertisements) and one type of publisher/publisher medium (website/webpage), but the embodiments of the systems and methods herein should be understood to include generally any type of digital content (e.g., articles, videos, advertisements, images, links, etc.) and publisher medium (e.g., website, web application, text messages, notifications, social network feeds, mobile app screens, other user interfaces, etc.) sufficient to provide the functionality described herein.

In some embodiments, when a user of a client computing device, such as client device 604, accesses a publisher's webpage 606 displayed on client device 604, for which the content serving system 602 is enabled, the content serving system 602 may receive one or more calls or requests for content items to display in relation to the publisher's displayed content. For example, in responding to a request (e.g., browser request), in some embodiments a publisher's web server may be configured to retrieve content items served by content serving platform 602 (or references to such items (e.g., URLs)), by making one or more calls or requests for content items, to incorporate into the webpage (e.g., page 606) that it serves to its client device's web browser, which displays the digital content items as part of the webpage, as represented by slots 606b displayed on webpage 606 alongside publisher's content 606a. In other embodiments, the publisher's web server may provide functionality in the content it serves to its client device (e.g., ad tags) that allows the web browser to make one or more calls or requests for digital content items served by content serving platform 602, to display as part of the webpage.

At 502, a first plurality of sets of event information associated with a first plurality of conversion events may be identified. In general, a conversion event of the first plurality of conversion events may be associated with a conversion of a content item (e.g., a content item, such as an advertisement, provided by the content system) via a client device, wherein the content item may be presented via the client device in response to a request for content. In some examples, a conversion event of the first plurality of events may be a conversion of an advertisement.

In general, a set of event information of the first plurality of sets of event information may comprise information associated with a conversion event of the first plurality of conversion events. In some examples, the set of event information may comprise content item information associated with a content item associated with the event (e.g., the content item may correspond to a content item that is clicked and converted in the event), client information associated with a client device and/or a user associated with the event (e.g., the client device may correspond to a client device that receives, selects and/or presents the content item, and/or the user may correspond to a user of the client device), and/or internet resource information associated with an internet resource associated with the event (e.g., the internet resource may correspond to an internet resource on which the content item is presented and/or converted in the event). The internet resource may be at least one of a web page, a website, an application (e.g., a client application, a mobile application, a platform, etc.).

In some embodiments, the content item information may comprise one or more of: a content item identifier that identifies the content item, a brand, advertiser and/or company associated with the content item, one or more topics of the content item, one or more products and/or services associated with the content item (e.g., the content item may be used to advertise and/or promote the one or more products and/or the one or more services), a format of the content item (indicative of whether the content item is audio, video or an image, for example), a duration and/or size of the content item, etc.

In some embodiments, the client information may comprise one or more of: a device identifier associated with the client device, an IP address associated with the client device, a media access control (MAC) address associated with the client device, a carrier identifier indicative of carrier information associated with the client device, a user identifier (e.g., at least one of a username, an email address, a user account identifier, etc.) associated with the client device and/or the user, a browser cookie (and/or a cookie identifier associated with the client device), activity information (e.g., click information, conversion information, search history information, website browsing history, email information, etc.) associated with the client device, the user identifier and/or the user, user demographic information (e.g., age, gender, etc.) associated with the client device (whether express or inferred from other information—user actions, browsing history, etc.), the user identifier, and/or the user, location information associated with the client device, the user identifier and/or the user, etc. In some examples, the client information may be determined based upon information received from the client device (and/or one or more other devices associated with the user and/or a user account associated with the user). Alternatively and/or additionally, the client information may be generated based upon information received from servers associated with internet resources (e.g., at least one of web pages, applications, mobile applications, etc.) accessed and/or visited by the client device and/or the user.

In some embodiments, the internet resource information may comprise one or more of: an internet resource identifier associated with the internet resource, a host device associated with the internet resource (e.g., the host device may comprise one or more computing devices, storage and/or a network configured to host the internet resource), a host identifier of the host device, a domain (e.g., a domain name, a top-level domain, etc.) associated with the internet resource, an application identifier associated with the internet resource (e.g., an application), a publisher identifier associated with a publisher of the internet resource, etc.

Referring to FIG. 6, in some embodiments, a logging system 608 may receive information 610 indicative of user actions from one or more client devices 604 and/or one or more computers (e.g., servers associated with internet resources accessed by the one or more client devices 604). For example, the information 610 may be indicative of user activity associated with conversion events of the first plurality of conversion events. The logging system 608 may be configured to log information associated with the user activity and/or generate the first plurality of sets of event information associated with the first plurality of conversion events. In some examples, the logging system 608 may be configured to output training data 612 to a machine learning training system 614.

At 504, a second plurality of sets of event information and a third plurality of sets of event information may be identified. In general, a set of event information of the second and third plurality of sets of event information may comprise information associated with a conversion event of a second and third plurality of conversion events, respectively. In some embodiments, the second and third plurality of conversion events may be second and third subsets of the first plurality of conversion events, respectively. Additionally, in some embodiments, the second and third plurality of sets of event information may comprise second and third subsets of the first plurality of sets of event information, respectively.

Additionally, in general, in some embodiments, the second plurality of sets of event information may be identified by evaluating the first plurality of sets of event information and determining whether a set meets a first criteria and identifying the set as one of the second plurality of sets of event information if the first criteria is met (or not met, depending on the nature of the criteria). In some embodiments, the evaluation of a set comprises determining whether the conversion event associated with the set meets the first criteria. In some embodiments, the events may be advertisement conversion events, and the first criteria is designed to measure affinity between predefined actions and clicks that comprise the conversion events. In some embodiments, the first criteria is a filtering procedure based on time delay between each predefined action and each click that comprise each conversion event.

Additionally, in general, in some embodiments, the third plurality of sets of event information may be identified by evaluating the first plurality of sets of event information and determining whether a set meets a second criteria and identifying the set as one of the third plurality of sets of conversion event information if the second criteria is met (or not met, depending on the nature of the criteria). In some embodiments, the evaluation of a set comprises determining whether the conversion event associated with the set meets a second criteria. In some embodiments, the conversion events may be advertisement conversion events, and the second criteria may be designed to measure lack of affinity between predefined actions and clicks that comprise the conversion events. In some embodiments, the second criteria is a filtering procedure based on time delay between each predefined action and each click that comprise each conversion event. In some embodiments, the second criteria comprises the first criteria, and the evaluation comprises determining that the first criteria has been met (that the conversion event in question is an outlier).

Referring to FIG. 6, in general, machine learning training system 614 may be configured to use training data 612 to train (such as via, e.g., data labeling techniques, etc.) a conversion rate prediction (pCVR) model 618. In some embodiments, training data 612 may comprise the first plurality of sets of event information. In some embodiments, machine learning training system 614 may be configured to include filtering unit 620.

In general, filtering unit 620 may be configured to receive training data 612 directly or indirectly from logging system 608 and apply a filtering procedure to it. Generally, the filtering procedure may be designed to determine whether a conversion event meets the criteria of being an outlier conversion event. Alternatively, in some embodiments the filtering procedure may be designed to determine whether a conversion event meets the criteria of having sufficient affinity between the conversion predefined action and click. In some embodiments, the same criteria may be utilized to make a binary classification whether a conversion event has sufficient affinity or may be considered an outlier. In some embodiments, filtering unit 620 may apply a filtering procedure to training data 612 and make a binary classification determination whether an event should be classified an outlier (lacking sufficient affinity). In some embodiments, filtering unit 620 may supply or make available the events that do not meet the outlier criteria classification and associated sets of event information for those events to pCVR model 618, whether as a data stream or otherwise (e.g., affinity data 622). In some embodiments, filtering unit 620 may supply or make available the events that do meet the outlier criteria classification and associated sets of event information for those events to bias calculation unit 624, whether as a data stream or as a logged entry reference (as in a table) or otherwise (e.g., outlier data 626). In some embodiments, affinity data 622 may comprise the second plurality of sets of event information and outlier data 626 may comprise the third plurality of sets of event information.

In general, the filtering procedure implemented by the embodiments disclosed herein may comprise any suitable filtering procedure sufficient to provide the functionality disclosed herein. In some embodiments, the filtering procedure comprises an outlier classification procedure, and may generally comprise any suitable procedure for identifying outliers in event data. In some embodiments, the filtering procedure implemented by filtering unit 620 may be an outlier event evaluation that comprises a procedure that calculates an average, A, of the delay times in a training set (i.e., in the first plurality of sets of event information), where delay time, d, for each conversion event is the elapsed time between the conversion event's predefined action and an associated click on an associated content item, and that filters from pCVR model training (by, e.g., classifying such events and related event information set as outlier data 626) any event whose delay time exceeds the average. In some embodiments, average, A, may be the current moving average. In some embodiments, average, A, may be the simple average of the training set. In some embodiments, filtering may not be performed (but average calculation may be performed) until a predefined minimal number of events have been evaluated, to establish sufficient statistics. In some embodiments, the minimum number may be thirty conversion events; in others, fifty conversion events; in others, seventy-five conversion events. In some embodiments, filtering may not be performed (but average calculations may be performed) until a predefined minimal time has elapsed since the start of the filtering procedure. In some embodiments, the minimum time may be 2 hours; in some embodiments, 8 hours; in some embodiments, 24 hours; in some embodiments, 48 hours.

In some embodiments, the filtering procedure implemented by filtering unit 620 may be an outlier event evaluation that comprises an implementation of Tukey's fence technique to identify outliers. See, for example, Tukey, John W. “Exploratory data analysis.” Vol. 2. 1977. In particular, in some embodiments, for a set of i conversion events, the procedure may calculate the current quartiles of the distribution of associated delay time values, di, using online percentage estimator (OPE), such as QR or T-digest. See, for example, Feldman, Dima, and Yuval Shavitt, “An optimal median calculation algorithm for estimating Internet link delays from active measurements,” 2007 Workshop on End-to-End Monitoring Techniques and Services (IEEE 2007); Dunning, Ted, and Otmar Ertl, “Computing extremely accurate quantiles using t-digests,” arXiv preprint arXiv:1902.04023 (2019).

For a given conversion event in the training set (i.e., the first plurality of sets of event information) the Tukey's upper fence value, TUFᵢ, may be given by:

$${TUF}_{i} = {Q}_{3 i} + 1.5 ( {Q}_{3 i -} {Q}_{1 i} ) , \qquad ( 1 )$$

where Q₁ᵢ and Q₃ᵢ are the first and third quartiles of the conversion delays time values evaluated to that point in the set, respectively. In some embodiments, the filtering unit 620 may filter any event whose delay time exceeds the current Tukey's upper fence value for the training set (the first plurality of sets of event information) by, e.g., classifying such events and related event information set as outlier data 626. In some embodiments, filtering may not be performed (but Tukey's upper fence calculation may be performed) until a minimum number of events have been evaluated, to establish sufficient statistics. In some embodiments, the predefined minimal number may be thirty conversion events; in others, fifty conversion events; in others, seventy-five conversion events. In some embodiments, filtering may not be performed (but Tukey's upper fence calculations may be performed) until a predefined minimal time has elapsed since the start of the filtering procedure. In some embodiments, the minimum time may be 2 hours; in some embodiments, 8 hours; in some embodiments, 24 hours; in some embodiments, 48 hours.

In some embodiments, the filtering procedure implemented by filtering unit 620 may be an outlier event evaluation that comprises calculating both the current moving average of delay times and the current Tukey's upper fence value, and selecting the larger value as the threshold value by which to classify the current delay time as an outlier (classifying as outliers any delay time that exceeds the current calculated threshold). In some embodiments, filtering may not be performed (but threshold calculation may be performed) until a minimum number of events have been evaluated, to allow for “cold start” effect. In some embodiments, the minimum number may be thirty conversion events; in others, fifty conversion events; in others, seventy-five conversion events. In some embodiments, filtering may not be performed (but threshold calculations may be performed) until a minimum time has elapsed since the start of the filtering procedure. In some embodiments, the minimum time may be 2 hours; in some embodiments, 8 hours; in some embodiments, 24 hours; in some embodiments, 48 hours.

At 506, in some examples, machine learning model training may be performed using the second plurality of sets of event information to generate a machine learning model to predict conversion rates of content items (e.g., shown as CVR model 618 in FIG. 6). As may be appreciated, since only the second plurality of sets of event information is utilized, the resulting model may be more accurate in its predicted CVR values for a given user and ad, since bias (represented by the third plurality of sets of event information) has been removed from the data set on which the model is trained. In some embodiments, the trained machine learning model (model 618), or portions thereof (e.g., updated model parameters, model coefficients, etc.) may be loaded as model data 628 to content serving system 602 to update its version of the model. In some embodiments, model 618 may be loaded to content serving system 602.

At 508, in some examples, a bias is calculated using the third plurality of sets of event information to compensate for the filtering of outlier conversions from the model training data. In some embodiments, the second plurality of sets of event information may also be used in the bias calculation. In general, any suitable manner of calculating a bias that may represent unaffiliated conversions based on outlier data, sufficient to provide the functionality disclosed herein, may be utilized. In some embodiments, as illustrated by system 600 in FIG. 6, the bias is calculated by bias calculation unit 624, using outlier data 626 (e.g., third plurality of sets of event information, all or portions of second plurality of sets of event information). In some embodiments, bias is calculated in relation to each content item of a plurality of content items in the system (e.g., stored in content serving system 602 and/or indexed and accessible by content serving system 602). In some embodiments, for each content item of a plurality of content items in the system, the following bias parameters are maintained (i.e., tallied and stored): (i) the number of clicks, #CLICKS; (ii) the number of typical conversion events, #CONV_{typical.}; and (iii) the number of outlier conversion events, #CONVₒᵤₜₗᵢₑᵣ. It should be noted that the bias parameters are maintained per content item. It should also be noted that, as used herein, unless context dictates otherwise, “typical” conversion events denotes conversions that have affinity to the associated click, as described above. In some embodiments, bias per item may be calculated as follows:

$$b = log ( \# {CONV}_{typical} + {CONV}_{outlier} ( \# CLICKS - \# {CONV}_{typical} ) \text{} / ( \# CLICKS - \# {CONV}_{typical} ) \# {CONV}_{typical} . \qquad ( 2 )$$

At 510, in some embodiments, a request for a content item (e.g., advertisement) in relation to a publisher's content (e.g., content 606 on client device 604) may be received by content serving system 602.

At 512, in some embodiments, a bidding process (auction) associated with the request for content may be performed by content serving system 602 to select a content item (e.g., content item 630 in FIG. 6) from the plurality of content items in the system to present via the client device 604. In some examples, the plurality of content items may comprise a first content item. It should be noted that, as used herein, a “first content item” and “each of the plurality of content items” may be used interchangeably, and “first bid value” and “each of a plurality of bid values” may be used interchangeably, and the description for one applies to the other, unless context dictates otherwise. Also, it should be noted that any description of a plurality of content items assumes, when used in connection with an auction, that the plurality of content items is participating in the auction or, if not, the relevant description applies to that subset which is participating in the auction.

In connection with the auction, the system may determine a first bid value associated with the first content item. In some embodiments, the first bid value may be determined based upon at least one of a budget associated with the first content item, a first target audience associated with the first content item, one or more advertisement campaign goals associated with the first content item, a first content item bid value associated with the first content item, etc.

Alternatively, and/or additionally, the first bid value may be determined based, in whole or in part, upon a first conversion probability associated with the first content item. In some examples, the first conversion probability may be calculated by machine learning model 618.

In some examples, machine learning model 618 may determine the first conversion probability based upon any or all of the information comprising event information in the second plurality of sets of event information associated with a second plurality of conversion events. Such information may comprise, in some examples, features such as a user profile, internet resource information associated with the internet resource(s) associated with the publisher and/or the advertiser, content item information associated with the first content item, etc.

In some embodiments, the bias calculated in 508 (the outlier bias) for the first content item may be added to the conversion probability calculated by machine learning model 618, to arrive at a conversion probability according to the disclosed embodiments. In some embodiments, the bid value utilized by the system in the relevant auction may comprise the conversion probability calculated with the outlier bias.

In some examples, a first plurality of bid values (comprising the first bid value) associated with the first plurality of content items (participating in the auction) may be compared by content serving system 602 to select a winner of the auction. In some examples, the winner may correspond to a content item, of the first plurality of content items, associated with a highest bid value among the first plurality of bid values. For example, the first content item 630 may be selected for presentation via the client device 604 based upon a determination that the first bid value is the highest bid value among the first plurality of bid values (and/or a determination that the first content item 630 is the winner of the auction).

In some examples, in response to selecting the first content item 630 for presentation via the client device 604, the first content item 630 may be transmitted to the client device 604 for display via the web page 606.

Although various examples of the present disclosure are described with respect to selection and/or presentation of content items comprising advertisements, embodiments are contemplated in which the content items comprise any type of content, such as at least one of search results, audio (e.g., songs, podcasts, etc.), video (e.g., movies, shows, video clips, etc.), articles, social media feeds, suggested content (e.g., links to videos, audio, articles, social media feeds, etc.), etc. while staying within the scope of the present disclosure.

Implementation of at least some of the disclosed subject matter may lead to benefits including, but not limited to, more accurate determination of conversion probabilities associated with content items—e.g., as a result of determining outlier bias associated with the third plurality of events, as a result of determining the conversion probabilities without inclusion of outlier conversions event information, such as by way of training the machine learning model using filtered sets of conversion event information and/or determining the conversion probabilities using the second plurality of sets of conversion event information, etc.). The more accurate determination of conversion probabilities may also lead to a more accurate and/or appropriate selection of a content item for presentation via a client device that has a higher probability of resulting in the content item being converted and/or a higher probability of a user consuming the content item to have an interest in the content item.

Alternatively and/or additionally, implementation of at least some of the disclosed subject matter may lead to benefits including an increase in generalized revenue for presenting content items via client devices (e.g., as a result of the more accurate determination of conversion probabilities that includes the bias when determining bid values based on calculated conversion probabilities, etc.).

Alternatively and/or additionally, implementation of at least some of the disclosed subject matter may lead to a more accurate and/or appropriate selection of a content item for presentation via a client device that has a higher probability of resulting in the content item being converted and/or a higher probability of a user consuming the content item to have an interest in the content item (e.g., as a result of the more accurate determination of conversion probabilities, etc.).

Alternatively and/or additionally, implementation of at least some of the disclosed subject matter may lead to benefits including a reduction in screen space and/or an improved usability of a display (e.g., of the client device) (e.g., as a result of the higher probability of the user consuming the content item to have an interest in the content item, wherein the user may not view content that the user does not have an interest in, wherein the user may not need to open a separate application and/or a separate window in order to find content having the subject matter that the user has an interest in, etc.).

Alternatively and/or additionally, implementation of at least some of the disclosed subject matter may lead to benefits including a reduction in bandwidth (e.g., as a result of reducing a need for the user to open a separate application and/or a separate window in order to search throughout the internet and/or navigate through internet content to find content that the user has an interest in).

In some examples, at least some of the disclosed subject matter may be implemented on a client device, and in some examples, at least some of the disclosed subject matter may be implemented on a server (e.g., hosting a service accessible via a network, such as the Internet).

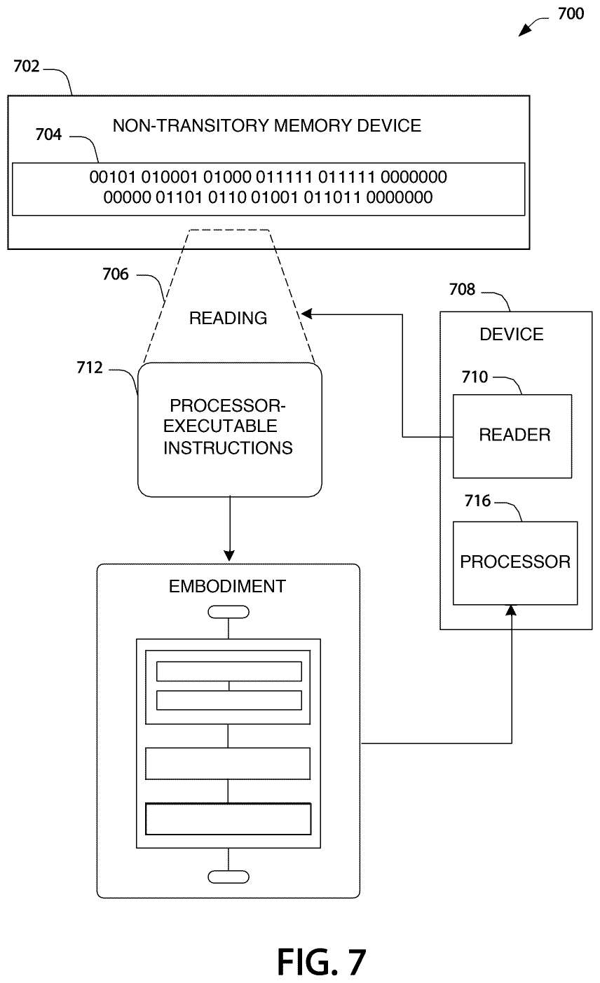

FIG. 7 is an illustration of a scenario 700 involving an example non-transitory machine readable medium 702. The non-transitory machine readable medium 702 may comprise processor-executable instructions 712 that when executed by a processor 716 cause performance (e.g., by the processor 716) of at least some of the provisions herein. The non-transitory machine readable medium 702 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 702 stores computer-readable data 704 that, when subjected to reading 806 by a reader 710 of a device 708 (e.g., a read head of a hard disk drive, or a read operation invoked on a solid-state storage device), express the processor-executable instructions 712. In some embodiments, the processor-executable instructions 712, when executed cause performance of operations, such as at least some of the example method 400 of FIG. 4, for example. In some embodiments, the processor-executable instructions 712 are configured to cause implementation of a system, such as at least some of the example system 600 of FIG. 6, for example.

### 3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” and/or the like is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In some embodiments, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

1. A method, comprising:
identifying a first plurality of sets of event information associated with a first plurality of conversion events;
filtering the first plurality of sets of event information to generate filtered sets of conversion event information by identifying (i) a second plurality of sets of event information for inclusion in the filtered sets of conversion event information and (ii) a third plurality of sets of event information for exclusion from the filtered sets of conversion event information, wherein the second plurality of sets of event information is associated with a plurality of typical conversion events identified from among the first plurality of conversion events and wherein the third plurality of sets of event information is associated with a plurality of outlier conversion events identified from among the first plurality of conversion events;
performing machine learning model training, using the filtered sets of conversion event information including the second plurality of sets of event information and excluding the third plurality of sets of event information, to generate a machine learning model;
calculating, for a plurality of content items, a plurality of bias values associated with the plurality of content items based on the third plurality of sets of event information excluded from the machine learning model training;
receiving, by a content serving system, a request for content associated with a client device;
responsive to receiving the request for content, for the plurality of content items, determining a plurality of associated conversion probabilities using (i) the machine learning model generated using the filtered sets of conversion event information and (ii) the plurality of bias values calculated based on the third plurality of sets of event information excluded from the filtered sets of conversion event information; and
selecting, based on the plurality of associated conversion probabilities, a content item from the plurality of content items for presentation via the client device.

2. The method of claim 1, wherein each of the sets of event information from the first plurality of sets of event information comprises a characteristic delay time value, such that the first plurality of sets of event information characterizes a first plurality of characteristic delay time values, and wherein the filtering comprises:
iteratively calculating an average characteristic delay time value from the first plurality of characteristic delay time values; and
determining, for each of the first plurality of characteristic delay time values, whether the average characteristic delay time value is greater and, for each of the first plurality of characteristic delay time values, if the average is determined to be greater, identifying an associated set of event information with the second plurality of sets of event information, and if not, identifying the associated set of event information with the third plurality of sets of event information.

3. The method of claim 1, wherein each of the sets of event information from the first plurality of sets of event information comprises a characteristic delay time value, such that the first plurality of sets of event information characterizes a first plurality of characteristic delay time values, and wherein the filtering comprises:
iteratively calculating a Tukey's upper fence value from the first plurality of characteristic delay time values; and
determining, for each of the first plurality of characteristic delay time values, whether the Tukey's upper fence value is greater and, for each of the first plurality of characteristic delay time values, if the Tukey's upper fence value is determined to be greater, identifying an associated set of event information with the second plurality of sets of event information, and if not, identifying the associated set of event information with the third plurality of sets of event information.

4. The method of claim 1, wherein each of the sets of event information from the first plurality of sets of event information comprises a characteristic delay time value, such that the first plurality of sets of event information characterizes a first plurality of characteristic delay time values, and wherein the filtering comprises:
iteratively calculating an average characteristic delay time value and a Tukey's upper fence value from the first plurality of characteristic delay time values;
determining, for each iteration, a greater value calculated from among the Tukey's upper fence value and the average characteristic delay time value, and identifying the greater value as an iteration threshold value; and
determining, for each of the first plurality of characteristic delay time values, whether the iteration threshold value is greater and, for each of the first plurality of characteristic delay time values, if the iteration threshold value is determined to be greater, identifying an associated set of event information with the second plurality of sets of event information, and if not, identifying the associated set of event information with the third plurality of sets of event information.

5. The method of claim 1, wherein the content serving system stores each of the plurality of content items and each of the plurality of bias values associated with the plurality of content items and, for each of the content items that are stored, maintains an updated tally of historical parameters comprising:
a number of clicks associated with the content item (#CLICKS), a number of typical conversion events associated with the content item (#CONV_{typical.}), and a number of outlier conversion events associated with the content item (#CONVₒᵤₜₗᵢₑᵣ), and wherein each of the bias values that are stored is associated with one of the stored content items, and wherein each of the bias values, b, is calculated according to the formula:
$$b = log ( \# {CONV}_{typical} + {CONV}_{outlier} ( \# CLICKS - \# {CONV}_{typical} ) \text{} / ( \# CLICKS - \# {CONV}_{typical} ) \# {CONV}_{typical} ) .$$

6. The method of claim 2, wherein determining, for each of the first plurality of characteristic delay time values, whether the average characteristic delay time value is greater does not begin until after the average characteristic delay time value has been calculated based on at least fifty characteristic delay time values of the first plurality of characteristic delay time values, and comprising identifying, for each of the first plurality of characteristic delay time values, an associated set of event information with the second plurality of sets of event information, until the average characteristic delay time value has been calculated based on forty nine characteristic delay time values of the first plurality of characteristic delay time values.

7. The method of claim 3, wherein determining, for each of the first plurality of characteristic delay time values, whether the Tukey's upper fence value is greater does not begin until after the Tukey's upper fence value has been calculated based on at least fifty characteristic delay time values of the first plurality of characteristic delay time values, and comprising identifying, for each of the first plurality of characteristic delay time values, an associated set of event information with the second plurality of sets of event information, until the Tukey's upper fence value has been calculated based on forty nine characteristic delay time values of the first plurality of characteristic delay time values.

8. The method of claim 4, wherein determining, for each of the first plurality of characteristic delay time values, whether the iteration threshold value is greater does not begin until after the iteration threshold value has been calculated based on at least fifty characteristic delay time values of the first plurality of characteristic delay time values, and comprising identifying, for each of the first plurality of characteristic delay time values, an associated set of event information with the second plurality of sets of event information, until the iteration threshold value has been calculated based on forty nine characteristic delay time values of the first plurality of characteristic delay time values.

9. The method of claim 1, comprising:
determining a plurality of bid values associated with the plurality of content items based on the plurality of associated conversion probabilities, wherein selecting the content item from the plurality of content items comprises selecting a content item having the highest associated bid value of the plurality of bid values.

10. The method of claim 1, comprising:
determining a plurality of bid values associated with the plurality of content items based on budget information associated with the content items.

11. A non-transitory machine readable medium having stored thereon processor-executable instructions that when executed cause performance of operations, the operations comprising:
identifying a first plurality of sets of event information associated with a first plurality of conversion events;
filtering the first plurality of sets of event information to generate filtered sets of conversion event information by identifying (i) a second plurality of sets of event information for inclusion in the filtered sets of conversion event information and (ii) a third plurality of sets of event information for exclusion from the filtered sets of conversion event information, wherein the second plurality of sets of event information is associated with a plurality of typical conversion events identified from among the first plurality of conversion events and wherein the third plurality of sets of event information is associated with a plurality of outlier conversion events identified from among the first plurality of conversion events;
performing machine learning model training, using the filtered sets of conversion event information including the second plurality of sets of event information and excluding the third plurality of sets of event information, to generate a machine learning model;
calculating, for a plurality of content items, a plurality of bias values associated with the plurality of content items based on the third plurality of sets of event information excluded from the machine learning model training;
receiving, by a content serving system, a request for content associated with a client device;
responsive to receiving the request for content, for the plurality of content items, determining a plurality of associated conversion probabilities using (i) the machine learning model generated using the filtered sets of conversion event information and (ii) the plurality of bias values calculated based on the third plurality of sets of event information excluded from the filtered sets of conversion event information; and
selecting, based on the plurality of associated conversion probabilities, a content item from the plurality of content items for presentation via the client device.

12. The non-transitory machine readable medium of claim 11, wherein each of the sets of event information from the first plurality of sets of event information comprises a characteristic delay time value, such that the first plurality of sets of event information characterizes a first plurality of characteristic delay time values, and wherein the filtering comprises:
iteratively calculating an average characteristic delay time value from the first plurality of characteristic delay time values; and
determining, for each of the first plurality of characteristic delay time values, whether the average characteristic delay time value is greater and, for each of the first plurality of characteristic delay time values, if the average is determined to be greater, identifying an associated set of event information with the second plurality of sets of event information, and if not, identifying the associated set of event information with the third plurality of sets of event information.

13. The non-transitory machine readable medium of claim 11, wherein each of the sets of event information from the first plurality of sets of event information comprises a characteristic delay time value, such that the first plurality of sets of event information characterizes a first plurality of characteristic delay time values, and wherein the filtering comprises:
iteratively calculating a Tukey's upper fence value from the first plurality of characteristic delay time values; and
determining, for each of the first plurality of characteristic delay time values, whether the Tukey's upper fence value is greater and, for each of the first plurality of characteristic delay time values, if the Tukey's upper fence value is determined to be greater, identifying an associated set of event information with the second plurality of sets of event information, and if not, identifying the associated set of event information with the third plurality of sets of event information.

14. The non-transitory machine readable medium of claim 11, wherein each of the sets of event information from the first plurality of sets of event information comprises a characteristic delay time value, such that the first plurality of sets of event information characterizes a first plurality of characteristic delay time values, and wherein the filtering comprises:
iteratively calculating an average characteristic delay time value and a Tukey's upper fence value from the first plurality of characteristic delay time values;
determining, for each iteration, a greater value calculated from among the Tukey's upper fence value and the average characteristic delay time value, and identifying the greater value as an iteration threshold value; and
determining, for each of the first plurality of characteristic delay time values, whether the iteration threshold value is greater and, for each of the first plurality of characteristic delay time values, if the iteration threshold value is determined to be greater, identifying an associated set of event information with the second plurality of sets of event information, and if not, identifying the associated set of event information with the third plurality of sets of event information.

15. The non-transitory machine readable medium of claim 11, wherein the content serving system stores each of the plurality of content items and each of the plurality of bias values associated with the plurality of content items and, for each of the content items that are stored, maintains an updated tally of historical parameters comprising:
a number of clicks associated with the content item (#CLICKS), a number of typical conversion events associated with the content item (#CONV_{typical.}), and a number of outlier conversion events associated with the content item (#CONVₒᵤₜₗᵢₑᵣ), and wherein each of the bias values that are stored is associated with one of the stored content items, and wherein each of the bias values, b, is calculated according to the formula:
$$b = log ( \# {CONV}_{typical} + {CONV}_{outlier} ( \# CLICKS - \# {CONV}_{typical} ) \text{} / ( \# CLICKS - \# {CONV}_{typical} ) \# {CONV}_{typical} ) .$$

16. The non-transitory machine readable medium of claim 12, wherein the operation of determining, for each of the first plurality of characteristic delay time values, whether the average characteristic delay time value is greater does not begin until after the average characteristic delay time value has been calculated based on at least fifty characteristic delay time values of the first plurality of characteristic delay time values, and comprising the operation of identifying, for each of the first plurality of characteristic delay time values, an associated set of event information with the second plurality of sets of event information, until the average characteristic delay time value has been calculated based on forty nine characteristic delay time values of the first plurality of characteristic delay time values.

17. The non-transitory machine readable medium of claim 13, wherein the operation of determining, for each of the first plurality of characteristic delay time values, whether the Tukey's upper fence value is greater does not begin until after the Tukey's upper fence value has been calculated based on at least fifty characteristic delay time values of the first plurality of characteristic delay time values, and comprising the operation of identifying, for each of the first plurality of characteristic delay time values, an associated set of event information with the second plurality of sets of event information, until the Tukey's upper fence value has been calculated based on forty nine characteristic delay time values of the first plurality of characteristic delay time values.

18. The non-transitory machine readable medium of claim 14, wherein the operation of determining, for each of the first plurality of characteristic delay time values, whether the iteration threshold value is greater does not begin until after the iteration threshold value has been calculated based on at least fifty characteristic delay time values of the first plurality of characteristic delay time values, and comprising the operation of identifying, for each of the first plurality of characteristic delay time values, an associated set of event information with the second plurality of sets of event information, until the iteration threshold value has been calculated based on forty nine characteristic delay time values of the first plurality of characteristic delay time values.

19. The non-transitory machine readable medium of claim 11, wherein the operations comprise determining a plurality of bid values associated with the plurality of content items based on the plurality of associated conversion probabilities, wherein the operation of selecting the content item from the plurality of content items comprises selecting a content item having the highest associated bid value of the plurality of bid values.

20. The non-transitory machine readable medium of claim 19, wherein the operations comprise determining a plurality of bid values associated with the plurality of content items based on budget information associated with the content items.
